(19) United States
(12) Patent Application Publication
(10) Pub. No.: US 2026/0195098 A1
(43) Pub. Date: Jul. 9, 2026

(54) DYNAMIC AND STATIC ASSESSMENT OF ARCHITECTURE DOCUMENT

(71) Applicant: International Business Machines Corporation, Armonk, NY (US)

(72) Inventors: Kun Yan Yin, NINGBO (CN); Xiao Bo Li, Ningbo (CN); Yuan Yuan Ding, Shanghai (CN); Shi Yun Liang, Shanghai (CN); Jing Zhang, Shanghai (CN); Chun Ni, Shenzhen (CN)

(21) Appl. No.: 19/008,839

(22) Filed: Jan. 3, 2025

(51) Int. Cl. G06F 8/10; G06F 8/20

(52) U.S. Cl. CPC G06F 8/10; G06F 8/20

(57) ABSTRACT

An example operation includes one or more of obtaining an architecture document and a requirements document of a software system, wherein the architecture document comprises deployment data, generating a description of differences which describes differences between the architecture document and the requirements document based on execution of at least one machine learning (ML) model on content from the architecture document and content from the requirements document, obtaining software system environment data from a productive environment in which the software system is executed, generating a second description of differences which describes differences between the architecture document and the productive environment in which the software system is executed based on execution of the at least one ML model on the deployment data and the software system environment data, and generating a summary of the architecture document based on execution of the at least one ML model on the description of the differences and the second description of the differences and outputting the summary to a graphical user interface (GUI).

### BACKGROUND

Architectural design in the software development process serves as a vital tool for effective communication, providing guidance for development, enhancing maintainability, and managing risks throughout the software development lifecycle. The architectural design contributes to the overall success of a project by ensuring architectural decisions align with the project's goals and requirements.

### SUMMARY

One example embodiment provides a method that may include one or more of obtaining an architecture document and a requirements document of a software system, wherein the architecture document comprises deployment data, generating a description of differences which describes differences between the architecture document and the requirements document based on execution of at least one machine learning (ML) model on content from the architecture document and content from the requirements document, obtaining software system environment data from a productive environment in which the software system is executed, generating a second description of differences which describes differences between the architecture document and the productive environment in which the software system is executed based on execution of the at least one ML model on the deployment data and the software system environment data, and generating a summary of the architecture document based on execution of the at least one ML model on the description of the differences and the second description of the differences and outputting the summary to a graphical user interface (GUI).

Another example embodiment provides a computer system that may include a processor set, a set of one or more computer-readable storage media, and program instructions, collectively stored in the set of one or more storage media, that cause the processor set to perform computer operations that may include one or more of obtaining an architecture document and a requirements document of a software system, wherein the architecture document comprises deployment data, generating a description of differences which describes differences between the architecture document and the requirements document based on execution of at least one machine learning (ML) model on content from the architecture document and content from the requirements document, obtaining software system environment data from a productive environment in which the software system is executed, generating a second description of differences which describes differences between the architecture document and the productive environment in which the software system is executed based on execution of the at least one ML model on the deployment data and the software system environment data, and generating a summary of the architecture document based on execution of the at least one ML model on the description of the differences and the second description of the differences and outputting the summary to a graphical user interface (GUI).

A further example embodiment provides a computer program product that may include a set of one or more computer-readable storage media, and program instructions, collectively stored in the set of one or more computer-readable storage media, for causing a processor set to perform computer operations that may include one of more of obtaining an architecture document and a requirements document of a software system, wherein the architecture document comprises deployment data, generating a description of differences which describes differences between the architecture document and the requirements document based on execution of at least one machine learning (ML) model on content from the architecture document and content from the requirements document, obtaining software system environment data from a productive environment in which the software system is executed, generating a second description of differences which describes differences between the architecture document and the productive environment in which the software system is executed based on execution of the at least one ML model on the deployment data and the software system environment data, and generating a summary of the architecture document based on execution of the at least one ML model on the description of the differences and the second description of the differences and outputting the summary to a graphical user interface (GUI).

### BRIEF DESCRIPTION OF THE DRAWINGS

FIG. 1 is a diagram illustrating a computing environment according to an embodiment of the instant solution.

FIG. 2A is a diagram illustrating a process of generating an assessment of the quality of an architecture document according to examples and features of the instant solution.

FIG. 2B is a diagram illustrating a process of generating a report with the results of the assessment according to examples and features of the instant solution.

FIG. 3A is a diagram illustrating a process of analyzing a structure of an architecture document according to examples and features of the instant solution.

FIG. 3B is a diagram illustrating a process of analyzing content within the architecture document according to examples and features of the instant solution.

FIG. 3C is a diagram illustrating a dynamic analysis process of an architecture document according to examples and features of the instant solution.

FIG. 3D is a diagram illustrating a process of prompting an ML model to generate an assessment report of the architecture document according to examples and features of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

Software architecture design is complex, which creates difficulties for subject matter experts (SMEs) to accurately review the quality of the design. Such a review process requires a need to understand the business requirements, the specific background of enterprise architecture guidance, other reference architectures, and the like. Furthermore, a typical architecture design document has multiple sections from different dimensions to describe the system being built. The reviewers need to manually review the document based on business requirements and the golden rules from each dimension. As a result, it can be difficult to identify the issues, especially on self-contradictory content between different sections. Furthermore, the software development process could be lengthy requiring new documents or updated documents which can be difficult for a human to track effectively.

There are various attributes that can be used to identify the quality of a software architecture document, for example, completeness, accuracy, consistency, traceability, and the like. For example, completeness may be used to indicate that the document includes all necessary information and details relevant to the architecture, including author and version, requirements, context graph, sequence graph, functional architecture graph and deployment architecture graph and key decisions. Accuracy may be used to indicate that the information is free from errors, contradictions, and outdated details. Some attributes can be detected by conflict of context, but others may need to be dynamically checked by production environments. Consistency may be used to indicate that there are no inconsistencies within the document or across related documents. Traceability may be used to indicate when the decisions, design elements, and requirements can be traced back to their origins and rationale.

The example embodiments are directed to an assessment generation system that can assess various attributes of a software architecture document including completeness, accuracy, consistency and traceability, and generate a document that describes the assessment including any missing components or incorrect content and provide notifications of the reasons for these missing and/or incorrect content enabling such content to be changed to thereby correct the content. The system described herein may rely on machine learning to perform both static document inspection and dynamic document inspection. Here, the static analysis can be used to verify whether the document's structure and internal content is consistent without relying on a live environment. It may ensure that essential sections (e.g., diagrams, version information) are present and that terminology and logic are consistent within the document. Meanwhile, the dynamic analysis may verify the document's accuracy against an actual productive environment where the system is running or a simulated system environment where the system is being simulated. Here, the system can verify whether architectural details align with the real system behavior, revealing issues that only appear during execution/runtime. Static analysis may be used to identify structural and logical issues early, while dynamic analysis may be used to verify real-world accuracy. Together, they provide a comprehensive assessment of the document's quality, ensuring both correctness and practical alignment with the system.

Some of the benefits of the system described herein are that the system provides an end-to-end workflow to estimate architecture document quality combining dynamic and static analysis based on machine learning. The system may auto correct any issues that are detected within the architecture document. As another example, the system may display a list of the issues on a GUI which can be reviewed by a human in the loop. The quality of the document can be evaluated using a combination of domain standards of a software system, and live runtime data of the software system in a productive environment, enabling a comprehensive identification of any errors or other quality issues. The system can provide an end-to-end overall automatic method to estimate the architecture document quality. The system can also remove the element of human error and reduce the efforts or need for human element. Furthermore, unified standards can be applied for quality evaluation of different architectures.

The assessment generation system described herein may be integrated within a software application, a service, or the like, which may be hosted by a host platform such as a cloud platform, a web server, a database, or the like.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

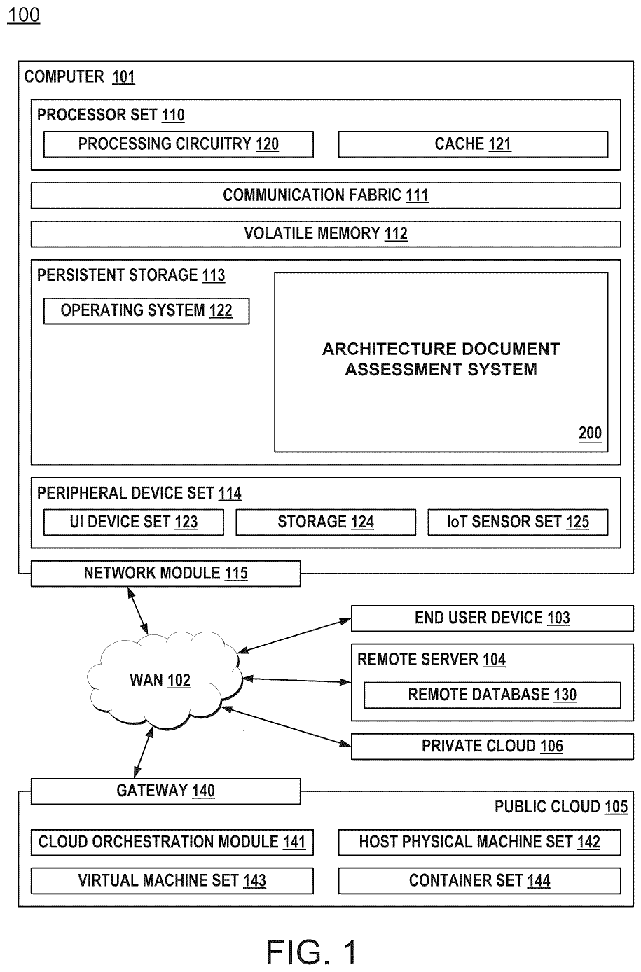

FIG. 1 illustrates a computing environment 100 according to an embodiment of the instant solution. Computing environment 100 contains an example of an environment for the execution of at least some of the computer code involved in performing the inventive methods.

Referring to FIG. 1, computing environment 100 contains an example of an environment for executing at least some of the computer code involved in performing the inventive methods, such as architecture document assessment system 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

CLOUD COMPUTING SERVICES AND/OR MICROSERVICES (not separately shown in FIG. 1) private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The example embodiments are directed to a system (e.g., a software application, etc.) that can generate a quality assessment of a software architecture document and provide actionable information that can be used to correct the software architecture document. In some embodiments, the software application may be hosted by a remote host such as a cloud platform and made accessible on a public network such as the Internet. A user may input a network address of the software application on the remote into a browser installed on a computing system and access the system described herein. As another example, the system may be installed on-premises and accessed by computers that are connected locally to the system.

The assessment process may include a combination of static analysis and dynamic analysis of the document content. For example, the static analysis may be used to check the document's structure and internal consistency without relying on a live environment. It ensures that essential sections (e.g., diagrams, version info) are present and that terminology and logic are consistent within the document. Furthermore, the dynamic analysis verifies the document's accuracy against the productive environment where the system is hosted or a simulated system environment. It confirms that architectural details align with the real system behavior, revealing issues that only appear during execution. In this system, static analysis may be used to identify and fix structural and logical issues within the architecture document at an early stage, while dynamic analysis may be used to confirm real-world accuracy.

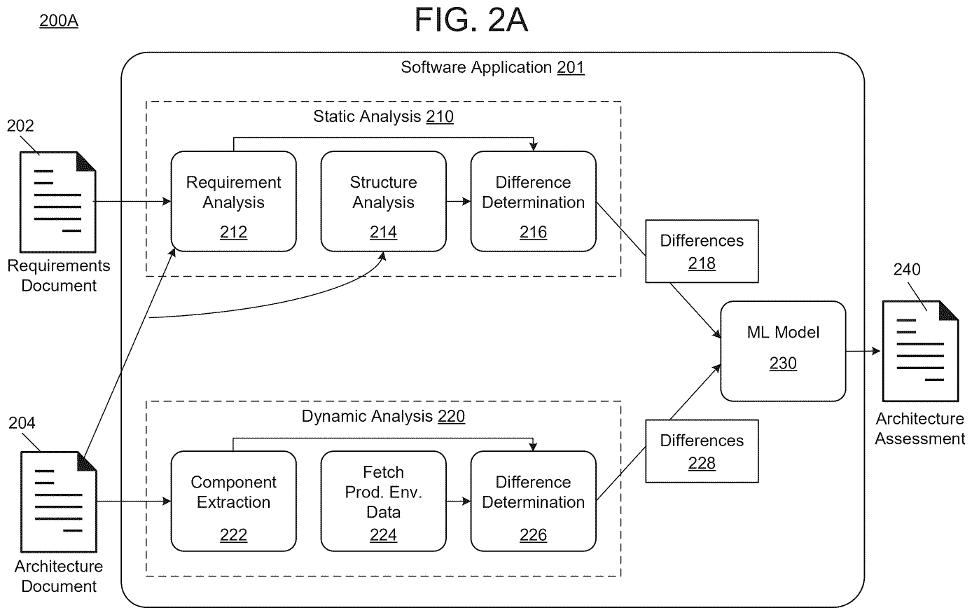

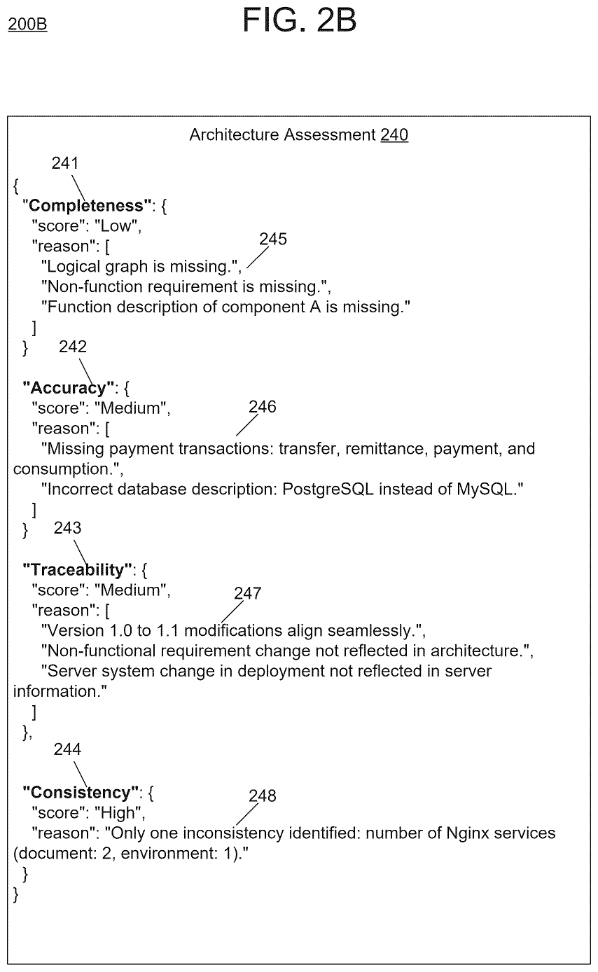

FIG. 2A illustrates a process 200A of generating an assessment of the quality of an architecture document 204 according to examples and features of the instant solution. Referring to FIG. 2A, a host platform (not shown) such as a cloud platform, a server, an on-premises system, a distributed system, and the like, may host a software application 201 which is capable of generating an assessment of the architecture document 204 of a software system such as a project, application, service, or the like. According to various embodiments, the software application 201 may generate an architecture assessment document 240 which includes a description of different attributes of the architecture document 204, a description of any missing content, a description of any incorrect content, and the like.

The software application 201 may execute a combination of static analysis 210 of the architecture document 204 and dynamic analysis 220 of the architecture document 204. The static analysis 210 and the dynamic analysis 220 may be performed simultaneously (e.g., in parallel, etc.). For example, the static analysis 210 may be executed by a first thread on a first processing core of the host platform while the dynamic analysis 220 may be executed by a second thread on a second processing core on the host platform. Both the static analysis 210 and the dynamic analysis 220 may generate a description of differences (and/or similarities). For example, the static analysis 210 may generate a description of differences 218 between the architecture document 204 of the software system and a requirements document 202 of the software system. Meanwhile, the dynamic analysis 220 may generate a description of differences 228 between the architecture document 204 (e.g., deployment data) and a live environment in which the software system is being executed.

The static analysis 210 checks the structure of the architecture document 204, including whether the architecture document 204 is missing any standard document components (e.g., component diagrams, context diagrams, deployment diagrams, architecture diagrams, design data, purpose and scope, views, principles and standards, etc.) and that the content within the standard document components is consistent with other documentation of the software system such as the requirements document 202. The static analysis 210 ensures that essential components are present, and that terminology and logic are consistent within the document. Meanwhile, the dynamic analysis 220 may verify the accuracy of the architecture document 204 against the productive environment where the software system is running or simulated system environment. It confirms that architectural details align with the real system behavior, revealing issues that only appear during execution. In this way, static analysis catches structural and logical issues, while dynamic analysis confirms real-world accuracy. Together, they provide a comprehensive assessment of the document's quality, ensuring both correctness and practical alignment with the system.

For example, the static analysis 210 may receive the requirements document 202 and the architecture document 204 and perform a requirement analysis 212 based on the content included in the requirements document 202 and the content included in the architecture document 204. The requirement analysis 212 may compare the content within each of the requirements document 202 and the architecture document 204 to ensure that terms, storage systems, service names, APIs, and the like, are the same and that no conflicts exist. In addition, a structural analysis 214 may analyze the structural components of the architecture document 204 to ensure that the architecture document 204 is not missing any standard components.

The results of the requirement analysis 212 and the structural analysis 214 may be provided to a difference determination module 216 which generates the description of the differences 218 between the requirements document 202 and the architecture document 204. The description of differences 218 may also indicate if the architecture document 204 is missing any structural components. Furthermore, the description of differences 218 may indicate that the content between the architecture document 204 and the requirements document 202 is aligned (no conflicts) and/or that the architecture document 204 is not missing any structural components.

The dynamic analysis 220 may include a component extraction module 222 which extracts the deployment architecture of the software system from the architecture document 204. A fetch productive environment data module 224 may fetch current runtime attributes of the software system from a productive environment where the software system is running. The deployment architecture and the runtime attributes may be provided to a difference determination module 226 which generates the description of differences 228 between the deployment data in the architecture document 204 and the runtime attributes of the software system. Here, the description of differences 228 may include a description of whether the services included in the deployment data are the same/aligned with the services running in the productive environment.

The description of differences 218 and the description of differences 228 may be input to a machine learning model 230 which is configured to generate the architecture assessment document 240 which includes a description of whether the content and structure of the architecture document 204 is correct, has any errors, is missing any parts, etc. For example, the architecture assessment document 240 may be displayed on a graphical user interface (GUI) of the software application 201 which may be accessed by a user device, for example, over a network.

FIG. 2B illustrates a process 200B of generating the architecture assessment document 240 with the results of the assessment according to examples and features of the instant solution. Referring to FIG. 2B, the static analysis 210 and the dynamic analysis 220 may provide the data necessary for building/generating the architecture assessment document 240. For example, the static analysis 210 may provide results which can be used to generate attributes of completeness 241 along with a description of any missing requirements 245, attributes of accuracy 242, along with any incorrect content 246, and traceability attributes 243 with a description of any incorrect changes or missing changes 247 made to the architecture document.

The dynamic analysis 220 may output results which enable the ML model 230 to determine consistency attributes 244 between the deployment graph/data in the architecture document 204 and the running system in the productive environment along with a description of any inconsistencies 248 between the deployment data in the architecture document 204 and the running system in the productive environment.

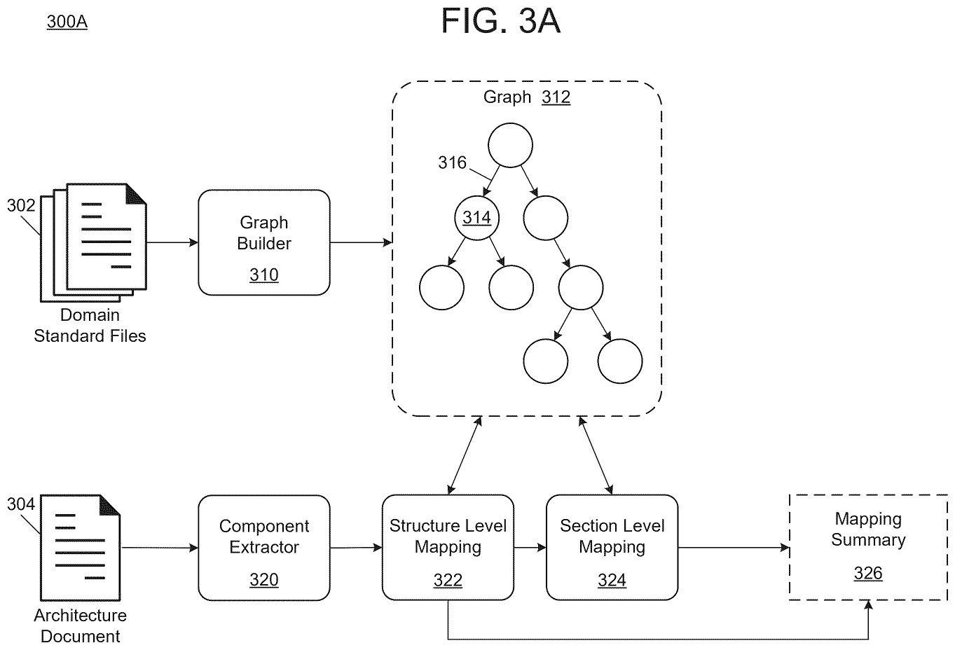

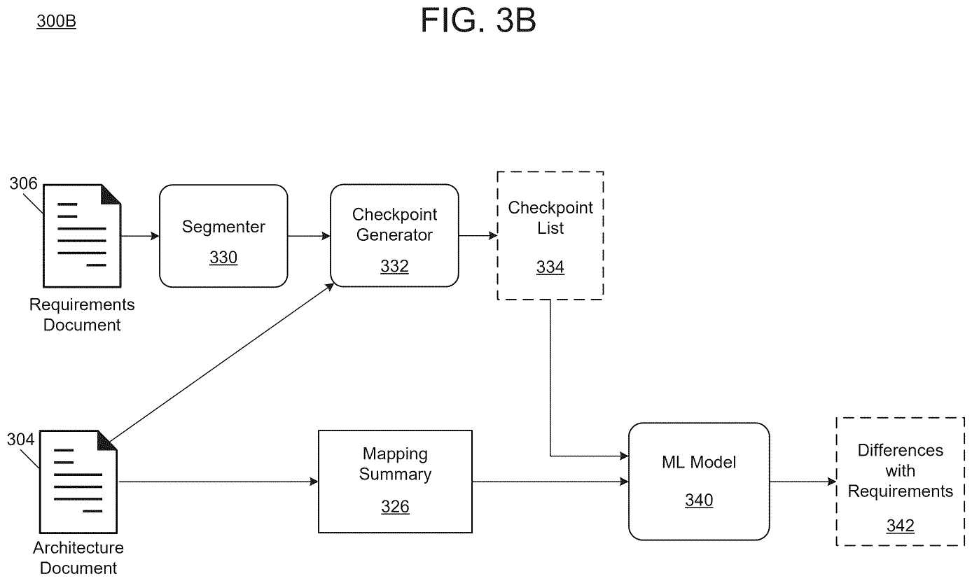

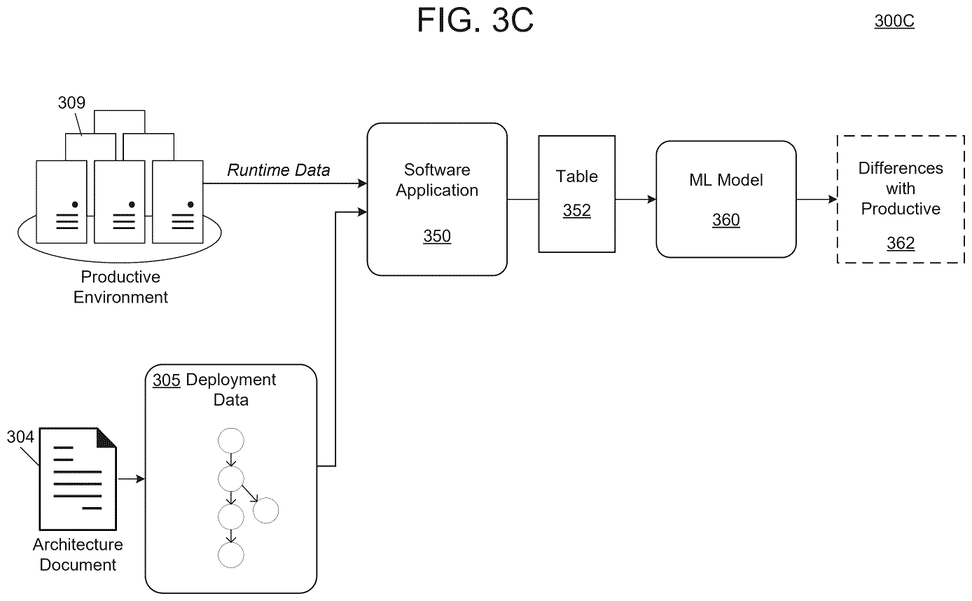

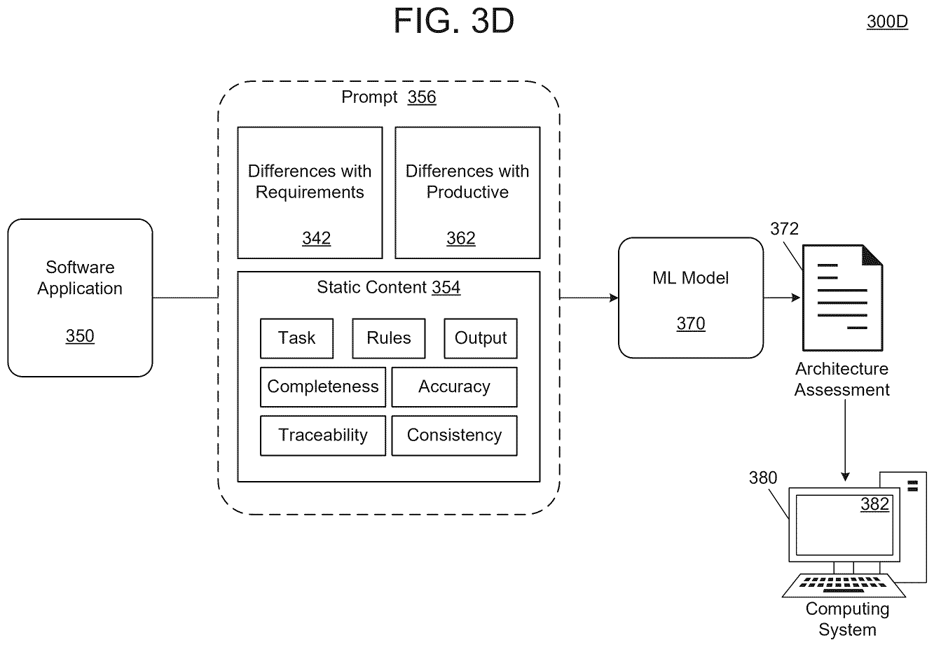

FIG. 3A illustrates a process 300A of analyzing a structure of an architecture document according to examples and features of the instant solution. Referring to FIG. 3A, the static analysis process described with respect to FIG. 2A may include the process 300A shown in FIG. 3A. In this example, an architecture document 304 may be assessed by the system. The architecture document 304 may correspond to a software system in a particular domain (e.g., data science, application development, entertainment, cybersecurity, web development, blockchain, big data, entertainment, etc.) The system may obtain domain standard files 302 which include domain-specific standardized files such as architecture documents with standardized components for the particular domain, best practices for the domain, publicly available domain architecture data, and the like.

According to various embodiments, the system may include a graph builder 310 which can ingest the domain standard files and map document components within the domain standard files into a knowledge graph (graph 312). Here, the graph 312 includes nodes 314 representing document components and edges 316 representing relationships between the document components. The graph 312 is populated with nodes representing standard document sections and elements as defined by the domain standards. The edges illustrate the relationships and dependencies among these nodes, reflecting how the architecture document should be structured according to established guidelines.

In general, a complete static architecture document should contain some key sections, such as an architecture overview, architecture design, key components, deployment architecture, etc. This standard information can often be collected in advance and used to build the graph 312. For the document architecture integrity check, a component extractor 320 may extract the document components (e.g., structural components, etc.) from the architecture document 304 and attempt to map them to the nodes 314 in the graph 312. The system may then perform a combination of structure level mapping 322 which includes mapping document content in the architecture document 304 to nodes in the graph 312 to determine if the architecture document 304 is missing any components, etc. and section level mapping 324 which includes comparing the content within the mapped components to ensure that content is not missing from the descriptions of the components. Both the structure level mapping 322 and the section level mapping 324 can be used to ensure that the architecture document 304 meets established standards. They both involve mapping document content to nodes in the knowledge graph, but they operate at different levels of detail, with the structure level mapping 322 focusing on the high-level section and the section level mapping focusing on the specific structural content within those sections. This layered approach helps ensure comprehensive quality checks for the architecture documentation.

The process may include multiple steps including a first step in which the domain standard files 302 are processed and extracted into graph 312 for node matching. Here, a graph schema can be constructed by the graph builder 310 with extracted entity relationships. In another step, for different document formats, such as word processor, PDF, etc., the system may locate the directory of the document, extract the contents of the directory, and segment the content. Next, the graph mapping may be performed including the structure level mapping 322, which is used to map structural components in graph schema and the section level mapping 324 which is used to map the graph schema section component.

A weight may be added to each node in the graph 312 to indicate how the content from the architecture document compares to the standard component. For example, a value of 1 may indicate a perfect alignment while a value of zero may indicate that the content is missing and the architecture document 304 is incomplete. The result of the mapping processes may include a mapping summary 326 generated by the software application. The mapping summary 326 may include a description of any missing components, a description of any incomplete components, an indication that all necessary components are correct, and the like.

The knowledge graph constructed in FIG. 3A is central to the static analysis process, allowing for the identification of missing components or inconsistencies within architecture documents. It serves as a reference point to verify whether all required sections and relationships are present. The extraction and segmentation of directory content of the architecture document may be used for understanding the document's structure, facilitating navigation, preparing for mapping, and conducting consistency checks. While the directory data itself may not be directly added to the knowledge graph, it serves as an input that guides how the architecture document is mapped to the nodes and relationships in the knowledge graph during the integrity checking process.

FIG. 3B illustrates a process 300B of analyzing content within the architecture document 304 with respect to a requirements document 306 according to examples and features of the instant solution. The process shown in FIG. 3B may be part of the static analysis 210 performed in the example of FIG. 2A. Referring to FIG. 3B, document content consistency and content conflict are important indicators of architectural document quality. The check is mainly reflected in two parts, the first part is that the content of the requirements document 306 conflicts with the architecture document 304, and the second part is that the context of the architecture document 304 itself conflicts. The consistency check between requirements document 306 and the architecture document 304 may include conflict analysis, version checking, and mapping changes to requirements.

For example, a segmenter 330 may perform a file segmentation process on the content within the requirements document 306 and a checkpoint generator 332 may generate a checkpoint list 334 based on a checkpoint generation and extraction process. The checkpoint generator 332 may match the relevant content and locate the relevant part of the architecture document 304 and create a list of checkpoints that serve as reference points for analysis and conflict checking. However, the specific checkpoints will vary depending on the content and the standard of the requirement documents. The checkpoint list 334 and the mapping summary 326 generated in the process of FIG. 3A may be input to a ML model 340 (e.g., an LLM, etc.) which generates a description of differences 342 between the requirements document 306 and the architecture document 304. The ML model 340 may perform conflict analysis using the ML model 340 to analyze and judge whether there is conflict.

The description of differences 342 may also include any conflicts between changes made to the requirements document 306 and the changes made to the architecture document 304. Here, the system may compare the version numbers of consecutive versions of architectural design documents. If a new version is detected, proceed with further comparison. The system may extract the changes between consecutive versions of architectural design documents. Utilize traditional text diffing algorithms or document comparison tools to identify all changes between versions. Furthermore, the system may use the ML model 340 to summarize the identified changes comprehensively, where changes would be specified in sections. Furthermore, the system may use the ML model 340 to compare the identified changes and the summary log section in the newest version. A match result should be returned to make sure if there is consistency between the log section and the actual change.

In some embodiments, if changes are detected between versions of architectural design documents, the changes may be linked to corresponding changes in requirements documentation. The system may extract and summarize the changes between consecutive versions of requirement documents. Furthermore, the system may use the ML model 340 to summarize and analyze the changes comprehensively. A matching result may be returned specifying if the changes between architectural design and requirement documents are consistent.

In this example, the requirements document 306 is a critical document that captures the necessary specifications for a software project, encompassing both functional and non-functional requirements. It is closely related to the architecture document 304, which translates these requirements into a structured design, ensuring that the system will fulfill its intended purpose. The system described herein may extract content from matching locations within the requirements document 306 and the architecture document 304.

The architecture document 304 may contain a summary log section which is important for version control for architectural design documents by documenting the changes made between versions in a clear and structured manner. It stores essential information such as version numbers, change descriptions, dates, authors, and affected sections, all of which help in tracking the evolution of the document and ensuring that stakeholders are informed of updates. The ML model 340 may perform a conflict check between the changes of the design of the software system in the architecture document 304 and the requirements document 306. The description of differences 342 may generate a description that compares the summarized modification for both documents.

FIG. 3C illustrates a dynamic analysis process 300C of an architecture document according to examples and features of the instant solution. For example, the process 300C shown in FIG. 3C may be part of the dynamic analysis 220 shown in FIG. 2A. Referring to FIG. 3C service data and other runtime attributes from a productive environment 309 where the software system is running may be obtained from the productive environment by a software application 350. Here, the software application may also be running within the productive environment 309 or may include an agent or other software system that is coupled to the software application 350 and which can detect runtime attributes of the software system in the productive environment 309 and provide them to the software application 350.

Meanwhile, the architecture document 304 may contain deployment data 305 therein such as a deployment graph. The deployment data may include a list of services (e.g., names, etc.), storage devices, APIs, etc. that are to be used during the live deployment of the software system. The software application 350 may build a table 352 which includes the runtime data from the productive environment 309 and the deployment data 305 from the architecture document 304. Furthermore, the table 352 may be input to a ML model 360 with generative capabilities which can generate a description of differences 362 between the runtime data in the productive environment 309 and the deployment data 305 from the architecture document 304.

In this example, the system may focus on the deployment architecture graph and determine whether it is consistent with production environment. The software application 350 may detect the deployment architecture graph in the architecture document 304, capture a snapshot of the graph and use an object detection model to segment the deployment architecture graph. The software application 350 may perform icon and text detection to have raw segmentation for the graph, then use a machine learning model (not shown) to combine the icon or box with nearby text and segment the graph with each of the components. The software application 350 may also perform optical character recognition (OCR) and parse the text in each of the graph nodes and use this text to represent the component.

Meanwhile, the software application 350 may include a fetch service that can be used to write customized scripts based on different deployment methods to fetch services of the software project from the actual productive environment. For example, the service could parse a configuration file to fetch the services based on a running container. The software application 350 may align the names of the services in the productive environment 309 with the names in the architecture document. Furthermore, the software application 350 may generate the table 352 which includes names and other attributes of the fetched services and names and other attributes of the services from the deployment graph in the architecture document 304. Meanwhile, the ML model 360 may compare the fetched services to the services from the deployment graph based on the table 352 and generate the description of the differences 362 based thereon.

The dynamic environment assessment is an essential part of ensuring that the architectural design remains accurate and relevant as the system evolves. By rigorously validating the deployment architecture against the live environment, the process helps maintain high standards of quality and consistency, ultimately contributing to the overall success of the software project. This step is vital for identifying discrepancies that could impact system performance, compliance, or user satisfaction. The production environment refers to the live operational context where the software system is deployed, involving both physical infrastructure and logical configurations. Meanwhile, segmentation refers to the individual parts of the deployment architecture graph that represent various elements of the software system as deployed in the production environment.

In this example, the fetch service may automate the discovery and extraction of service data from the productive environment 309 based on the specifics of the deployment setup, facilitating accurate comparison with the deployment architecture graph. The script is generated based on the environment's requirements and may utilize various APIs and command-line tools to gather relevant service information effectively. The table 352 stores essential information about each service deployed in the production environment, including names, identifiers, versions, statuses, and configurations. Its purpose is to provide a centralized reference for validation, monitoring, reporting, and troubleshooting, thereby facilitating effective management of services within the software architecture.

FIG. 3D illustrates a process 300D of prompting an ML model 370 to generate an architecture assessment document/report of the quality of the architecture document 304 according to examples and features of the instant solution. Referring to FIG. 3D, the software application 350 may generate a prompt 356 which includes content for prompting the ML model 370 to generate the architecture assessment document 372. Here, the software application 350 may use a prompt template to generate the prompt 356. The prompt template may include a section for dynamically added content including the description of differences 342 generated from the static analysis process of FIG. 3B, and the description of differences 362 generated from the dynamic analysis process of FIG. 3C.

In addition, the prompt template may also include static content 354 such as tasks, rules, output requirements, and attributes to be analyzed for quality such as completeness, accuracy, traceability, and consistency. The attributes to be analyzed may include rules that specify how the ML model 370 should generate a score for each of the attributes based on the differences included in the description of differences 342 and the description of differences 362. Meanwhile, the task may include instructions which define the output goal of the ML model 370.

An example of the task may include the following: “You are an architecture document quality assessment expert. You need to evaluate the architecture document quality. You need to analyze and evaluate the four aspects of completeness, accuracy, traceability, and consistency based on the architecture analysis results, and finally generate a complete evaluation report, giving the scores and summary of the four aspects of completeness, accuracy, traceability, and consistency. Based on the analysis results and Rules, the scores for each aspect of architecture include Low, Media, and High.”

In this example, the ML model 370 generates the architecture assessment document 372, and outputs the architecture assessment document 372 to a graphical user interface (GUI) of the software application 350 which may be viewed by a computing system 380 that is connected to the host platform over a computer network. The computing system 380 may include a browser or other viewer which enables a display device 382 of the computing system 380 to access the software application 350 and view the GUI with the architecture assessment document 372.

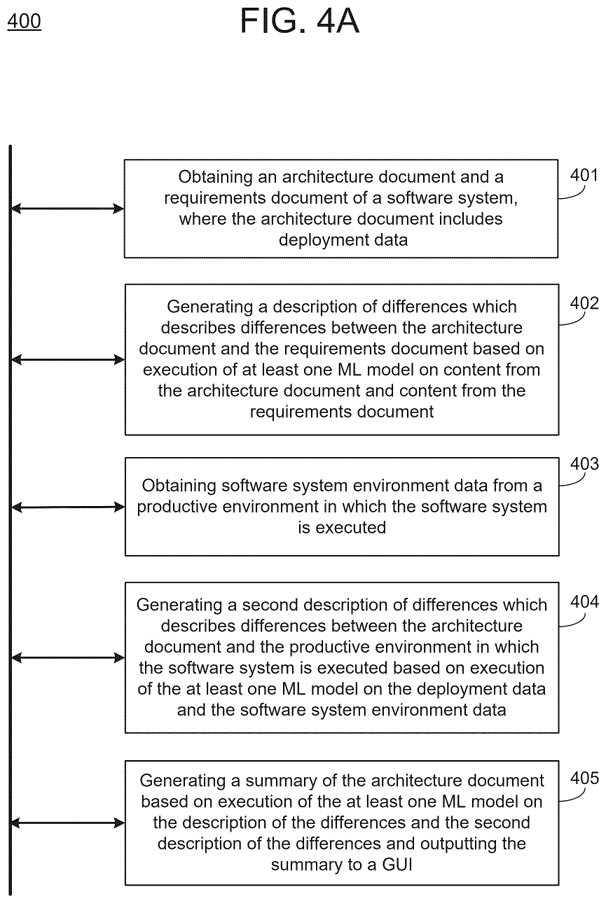

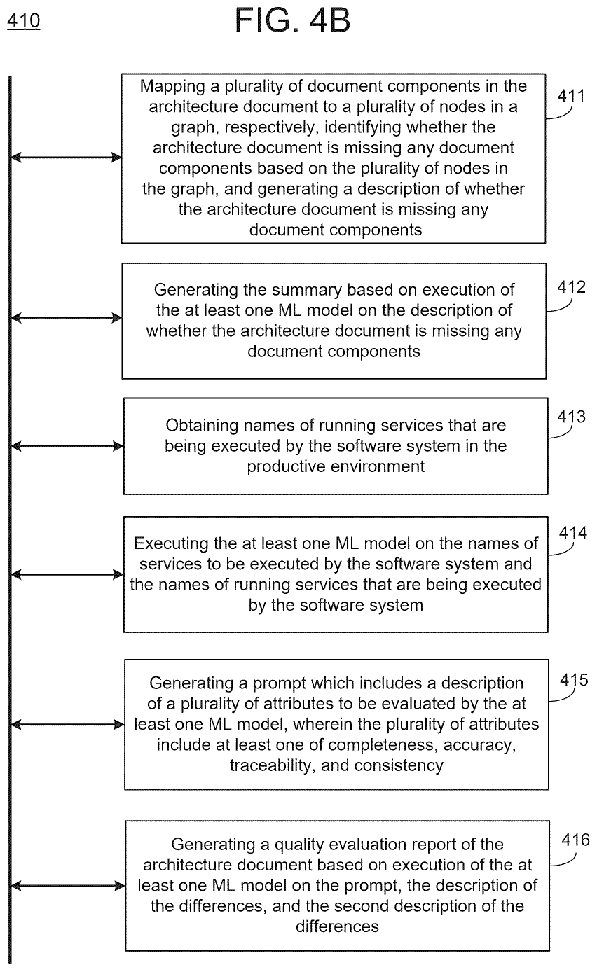

FIG. 4A illustrates a flow diagram of a method 400, according to example embodiments. Referring to FIG. 4A, in 401, the method may include obtaining an architecture document and a requirements document of a software system, wherein the architecture document comprises deployment data. In 402, the method may include generating a description of differences which describes differences between the architecture document and the requirements document based on execution of at least one machine learning (ML) model on content from the architecture document and content from the requirements document. In 403, the method may include obtaining software system environment data from a productive environment in which the software system is executed. In 404, the method may include generating a second description of differences which describes differences between the architecture document and the productive environment in which the software system is executed based on execution of the at least one ML model on the deployment data and the software system environment data. In 405, the method may include generating a summary of the architecture document based on execution of the at least one ML model on the description of the differences and the second description of the differences and outputting the summary to a graphical user interface (GUI).

FIG. 4B illustrates a flow diagram of a method 410, according to example embodiments. Referring to FIG. 4B, in 411, the method may include mapping a plurality of document components in the architecture document to a plurality of nodes in a graph, respectively, identifying whether the architecture document is missing any document components based on the plurality of nodes in the graph, and generating a description of whether the architecture document is missing any document components. In 412, the method may include generating the summary based on execution of the at least one ML model on the description of whether the architecture document is missing any document components. In 413, the deployment data may include a deployment graph with names of services to be executed by the software system, and the obtaining the software system environment data may include obtaining names of running services that are being executed by the software system in the productive environment.

In 414, the method may include executing the at least one ML model on the names of services to be executed by the software system and the names of running services that are being executed by the software system. In 415, the method may include generating a prompt which includes a description of a plurality of attributes to be evaluated by the at least one ML model, wherein the plurality of attributes includes at least one of completeness, accuracy, traceability, and consistency. In 416, the method may include generating a quality evaluation report of the architecture document based on execution of the at least one ML model on the prompt, the description of the differences, and the second description of the differences.

Detailed descriptions of training a machine learning model and executing a machine learning model are further described and depicted herein.

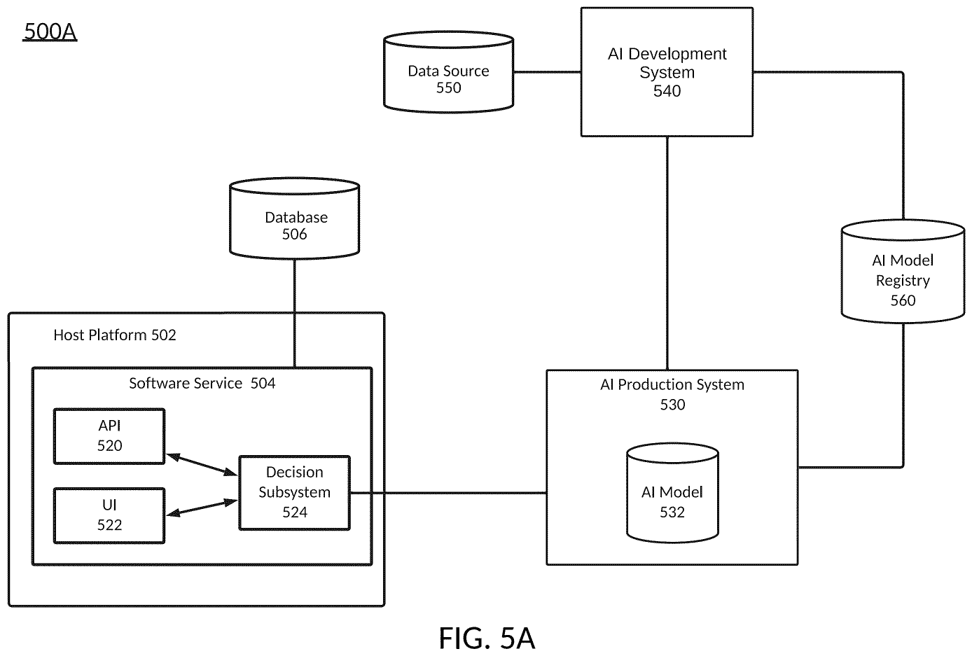

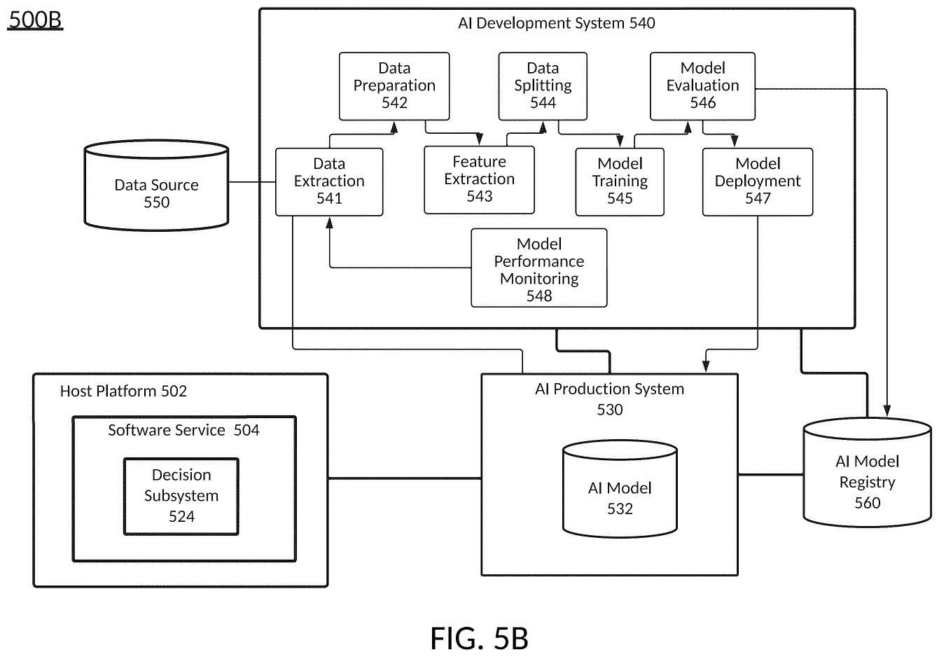

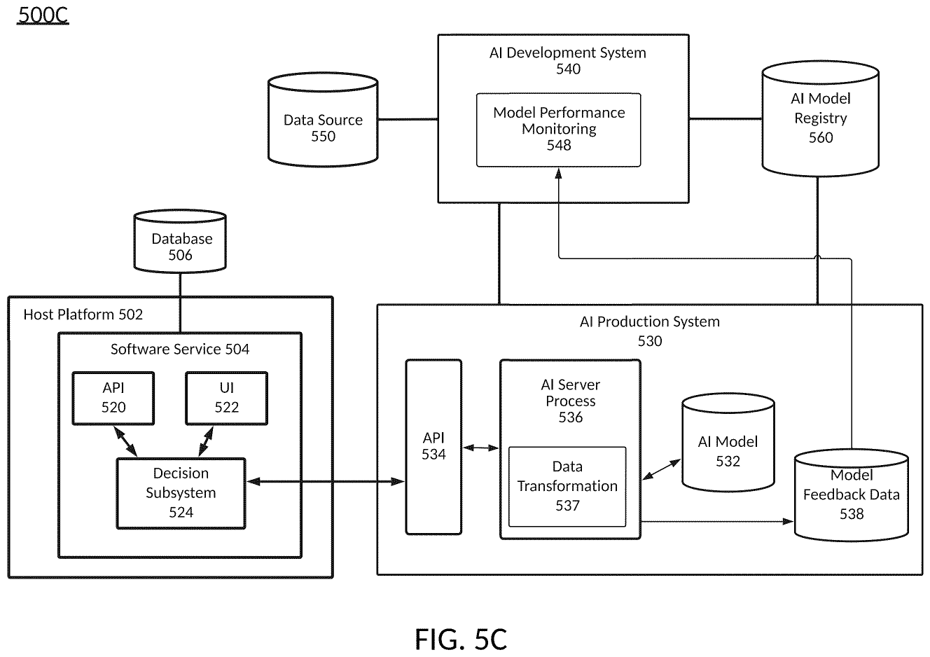

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies, and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI models refer to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks, and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or

other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks, and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
obtaining an architecture document and a requirements document of a software system, wherein the architecture document comprises deployment data;
generating a description of differences which describes differences between the architecture document and the requirements document based on execution of at least one machine learning (ML) model on content from the architecture document and content from the requirements document;
obtaining software system environment data from a productive environment in which the software system is executed;
generating a second description of differences which describes differences between the architecture document and the productive environment in which the software system is executed based on execution of the at least one ML model on the deployment data and the software system environment data; and
generating a summary of the architecture document based on execution of the at least one ML model on the description of the differences and the second description of the differences and outputting the summary to a graphical user interface (GUI).

2. The method of claim 1, further comprising mapping a plurality of document components in the architecture document to a plurality of nodes in a graph, respectively, identifying whether the architecture document is missing any document components based on the plurality of nodes in the graph, and generating a description of whether the architecture document is missing any document components.

3. The method of claim 2, wherein the generating the summary of the architecture document further comprises generating the summary based on execution of the at least one ML model on the description of whether the architecture document is missing any document components.

4. The method of claim 1, wherein the deployment data comprises a deployment graph with names of services to be executed by the software system, and the obtaining the software system environment data comprises obtaining names of running services that are being executed by the software system in the productive environment.

5. The method of claim 4, wherein the generating the second description of differences comprises executing the at least one ML model on the names of services to be executed by the software system and the names of running services that are being executed by the software system.

6. The method of claim 1, further comprising generating a prompt which includes a description of a plurality of attributes to be evaluated by the at least one ML model, wherein the plurality of attributes include at least one of completeness, accuracy, traceability, and consistency.

7. The method of claim 6, wherein the generating the summary of the architecture document comprises generating a quality evaluation report of the architecture document based on execution of the at least one ML model on the prompt, the description of the differences, and the second description of the differences.

8. A computer system comprising:
a processor set;
a set of one or more computer-readable storage media; and
program instructions, collectively stored in the set of one or more storage media, that cause the processor set to perform computer operations comprising:
obtaining an architecture document and a requirements document of a software system, wherein the architecture document comprises deployment data;
generating a description of differences which describes differences between the architecture document and the requirements document based on execution of at least one machine learning (ML) model on content from the architecture document and content from the requirements document;
obtaining software system environment data from a productive environment in which the software system is executed;
generating a second description of differences which describes differences between the architecture document and the productive environment in which the software system is executed based on execution of the at least one ML model on the deployment data and the software system environment data; and
generating a summary of the architecture document based on execution of the at least one ML model on the description of the differences and the second description of the differences and outputting the summary to a graphical user interface (GUI).

9. The computer system of claim 8, wherein the computer operations further comprise mapping a plurality of document components in the architecture document to a plurality of nodes in a graph, respectively, identifying whether the architecture document is missing any document components based on the plurality of nodes in the graph, and generating a description of whether the architecture document is missing any document components.

10. The computer system of claim 9, wherein the generating the summary of the architecture document further comprises generating the summary based on execution of the at least one ML model on the description of whether the architecture document is missing any document components.

11. The computer system of claim 8, wherein the deployment data comprises a deployment graph with names of services to be executed by the software system, and the obtaining the software system environment data comprises obtaining names of running services that are being executed by the software system in the productive environment from the productive environment.

12. The computer system of claim 11, wherein the generating the second description of differences comprises executing the at least one ML model on the names of services to be executed by the software system and the names of running services that are being executed by the software system.

13. The computer system of claim 8, wherein the computer operations further comprise generating a prompt which includes a description of a plurality of attributes to be evaluated by the at least one ML model, wherein the plurality of attributes include at least one of completeness, accuracy, traceability, and consistency.

14. The computer system of claim 13, wherein the generating the summary of the architecture document comprises generating a quality evaluation report of the architecture document based on execution of the at least one ML model on the prompt, the description of the differences, and the second description of the differences.

15. A computer program product comprising:
a set of one or more computer-readable storage media; and
program instructions, collectively stored in the set of one or more computer-readable storage media, for causing a processor set to perform computer operations comprising:
obtaining an architecture document and a requirements document of a software system, wherein the architecture document comprises deployment data;
generating a description of differences which describes differences between the architecture document and the requirements document based on execution of at least one machine learning (ML) model on content from the architecture document and content from the requirements document;
obtaining software system environment data from a productive environment in which the software system is executed;
generating a second description of differences which describes differences between the architecture document and the productive environment in which the software system is executed based on execution of the at least one ML model on the deployment data and the software system environment data; and
generating a summary of the architecture document based on execution of the at least one ML model on the description of the differences and the second description of the differences and outputting the summary to a graphical user interface (GUI).

16. The computer program product of claim 15, wherein the computer operations further comprise mapping a plurality of document components in the architecture document to a plurality of nodes in a graph, respectively, identifying whether the architecture document is missing any document components based on the plurality of nodes in the graph, and generating a description of whether the architecture document is missing any document components.

17. The computer program product of claim 16, wherein the generating the summary of the architecture document further comprises generating the summary based on execution of the at least one ML model on the description of whether the architecture document is missing any document components.

18. The computer program product of claim 15, wherein the deployment data comprises a deployment graph with names of services to be executed by the software system, and the obtaining the software system environment data comprises obtaining names of running services that are being executed by the software system in the productive environment from the productive environment.

19. The computer program product of claim 18, wherein the generating the second description of differences comprises executing the at least one ML model on the names of services to be executed by the software system and the names of running services that are being executed by the software system.

20. The computer program product of claim 15, wherein the computer operations further comprise generating a prompt which includes a description of a plurality of attributes to be evaluated by the at least one ML model, wherein the plurality of attributes include at least one of completeness, accuracy, traceability, and consistency.
